(19) United States
(12) Patent Application Publication
(10) Pub. No.: US 2009/0000910 A1
(43) Pub. Date: Jan. 1, 2009

(54) Piece Turning Apparatus For Selectively Turning Elongated Pieces of Lumber Carried in Sequence By a Conveyor

(76) Inventor: Martin Perreault, Dolbeau (CA)

Correspondence Address: KNOBBE MARTENS OLSON & BEAR LLP, 2040 MAIN STREET, FOURTEENTH FLOOR, IRVINE, CA, 92614, US

(21) Appl. No.: 10/585,508

(22) PCT Filed: Jan. 7, 2005
(86) PCT No.: PCT/CA05/00020

§ 371 Date: Jul. 7, 2006

(30) Foreign Application Priority Data
Jan. 8, 2004 (CA) 2,454,986

(51) Int. Cl. B27B 31/04; B65G 47/252; B65G 47/248

(52) U.S. Cl. 198/379; 198/395; 414/758

(57) ABSTRACT

A system for selectively turning elongated pieces comprising a conveyor transversally receiving and carrying in a sequence the elongated pieces along a transfer course. A piece turning apparatus is mounted next to the conveyor and has a number of turning hands in which an end of one of the elongated pieces is engageable so that rotation of the turning hand effects a turning of the one of the elongated pieces about a longitudinal axis thereof when the end of the one of the elongated pieces is engaged in the turning hand. Carriages are distributively mounted onto the endless driving body and supporting respectively the turning hands so that each one of the turning hands successively moves into an engaging position with an end of one of the elongated pieces as the one of the elongated pieces is carried by the conveyor. A cam body drives the turning hands in rotation.

### FIELD OF THE INVENTION

The present invention relates in general to equipment for processing pieces of lumber. More particularly, it relates to an apparatus for selectively turning elongated pieces of lumber to set their wany faces up, in order to maximize planer mill recovery by minimizing waste.

### BACKGROUND

Pieces of lumber manufactured by sawmills are not free of imperfections, irregularities, etc. Occasionally, a piece of lumber may have a wany face, i.e. an uneven surface. For economical and technical reasons, the wany face of the piece of lumber has to be face up for a planer to eliminate the wane or at least reduce it. It is known in the art that general piece of lumber appearance may be significantly improved if the piece of lumber is fed into the planer wany face up.

Although various piece turning apparatuses are known in the art for turning pieces of lumber carried in sequence by a conveyor, most of these apparatuses lack the ability to selectively turn the pieces. Not all the pieces have to be turned since they may not have irregularities, wanes, etc, or their wany face may already be facing up. Furthermore, the high speed velocity at which the pieces of lumber are carried by the conveyor increases the difficulty to selectively and automatically turn the pieces of lumber wany face up. Therefore, there is a need for a piece turning apparatus for selectively turning pieces of lumber carried in sequence by a conveyor.

### SUMMARY OF THE INVENTION

An object of the present invention is to propose a piece turning apparatus for selectively turning elongated pieces so that the pieces are fed into the planer wany faces up.

Another object of the present invention is to propose such a piece turning apparatus for selectively turning pieces carried in sequence by a conveyor at a high speed rate, for example 200 pieces of lumber per minute.

Another object of the present invention is to provide a system for selectively turning pieces of lumber carried in sequence by a conveyor, using an electronic reading unit for reading the shape of the pieces and detecting irregularities or/and wany faces for determining which pieces to turn.

According to the present invention, there is provided a piece turning apparatus for selectively turning elongated pieces carried in a sequence by a conveyor, comprising a number of turning hands. Each turning hand has upper and lower facing jaws between which an end of one of the elongated pieces is engageable so that rotation of the turning hand effects a turning of the one of the elongated pieces about a longitudinal axis thereof when the end of the one of the elongated pieces is engaged in the turning hand. The apparatus also comprises a number of carriages to which the turning hands are respectively rotatably mounted, and an endless driving body mountable next to the conveyor and defining running courses between opposite turning end courses. One of the running courses is parallel with the conveyor when the endless driving body is mounted next to the conveyor. The carriages are distributively mounted onto the endless driving body and supporting respectively the turning hands so that each one of the turning hands successively moves into an engaging position with an end of one of the elongated pieces as the one of the elongated pieces is carried by the conveyor. The apparatus also comprises a motor unit operatively coupled to the endless driving body in a driving engagement therewith and a cam body movable between an active position in which the cam body drives one of the turning hands in rotation using motion of the one of the turning hands while the one of the turning hands is in said engaging position, and an inactive position in which the cam body stands away from the one of the turning hands. The apparatus also comprises an actuator controllably moving the cam body between the active and inactive positions in response to a piece turning control signal.

According to the present invention, there is also provided a system for selectively turning elongated pieces, comprising a conveyor for receiving and carrying the elongated pieces in a sequence along a transfer course. The elongated pieces have one end extending along an alignment line when moving over a downstream portion of the conveyor. The system also comprises a piece turning apparatus as previously defined, positioned on a side of the downstream portion of the conveyor and synchronized therewith, for engagement of the ends of the elongated pieces between the jaws of the turning hands respectively.

### BRIEF DESCRIPTION OF THE DRAWINGS

These and other objects and advantages of the invention will become apparent upon reading the detailed description and upon referring to the drawings in which:

FIG. 1 is a top view of a system for selectively turning elongated pieces of lumber carried in sequence by a conveyor according to the present invention.

FIG. 2 is an enlarged top view of the system shown in FIG. 1.

FIG. 3 is a front view of a turning hand according to the present invention.

FIG. 4 is a side view of the turning hand shown in FIG. 3.

FIG. 5 is a top view of the turning hand shown in FIG. 4.

FIG. 6 is a front view of a piece turning apparatus according to the present invention.

FIG. 7 is a side view of the piece turning apparatus shown in FIG. 6.

FIG. 8 is a top view of the piece turning apparatus shown in a FIG. 7.

FIG. 9 is a front view of a piece turning apparatus showing a cam body driving turning hands in rotation according to the present invention.

FIG. 10 is a side view of the cam body shown in FIG. 9.

FIG. 11 is a top view of the cam body shown in FIG. 10.

FIG. 12 is a front view of a first synchronizing unit mounted onto a conveyor according to the present invention.

FIG. 13 is a side view of the first synchronizing unit shown in FIG. 12.

FIG. 14 is a top view of the first synchronizing unit shown in FIG. 13.

FIGS. 15a and 15b are front and side views respectively of a tensioning device of the first synchronizing unit shown in FIG. 12.

FIGS. 16a and 16b are front and side views respectively of a positioning device of the first synchronizing unit shown in FIG. 12.

FIG. 17 is a front view of a second synchronizing unit mounted onto the piece turning apparatus according to the present invention.

FIG. 18 is a side view of the second synchronizing unit shown in FIG. 17.

FIG. 19 is a top view of the second synchronizing unit shown in FIG. 18.

### DESCRIPTION OF PREFERRED EMBODIMENTS

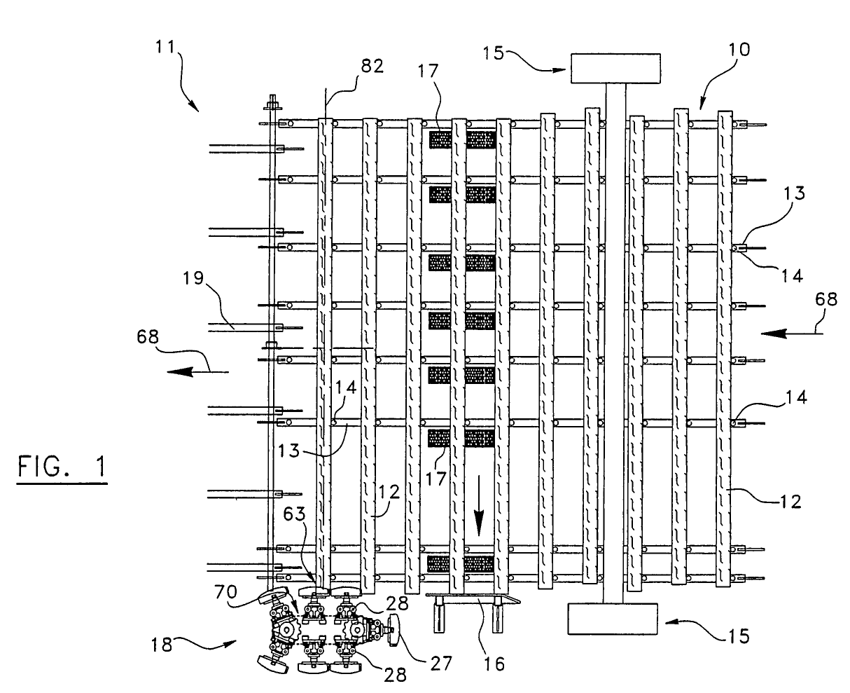

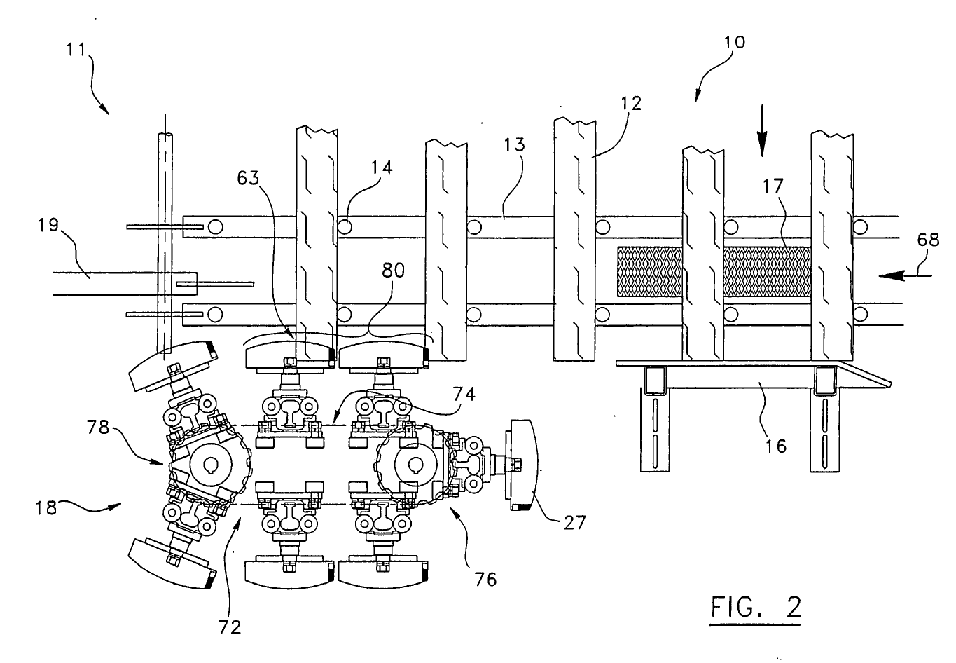

Referring to FIGS. 1 and 2, there is shown a system for selectively turning elongated pieces 12 along with a piece turning apparatus 18 according to the present invention. Although the elongated pieces 12 are preferably pieces of lumber, the system may also be used for turning other types of elongated pieces. For clarity, the pieces of lumber will be referred to only as pieces throughout the description.

The pieces 12 are laid down one by one onto endless chains 13 of a transfer conveyor 10. The transfer conveyor 10 receives and carries the pieces 12 in a sequence along a transfer course, as depicted by arrow 68. The endless chains 13 are parallel with one another and spaced apart. The endless chains 13 may be provided with lugs 14 at regular intervals to keep a constant distance between the pieces 12. The lugs 14 are pressing against a back side of the pieces 12 when the same are driven forward by the endless chains 13. An unloading conveyor 11 is located at an end of the transfer conveyor 10 for carrying the pieces 12 from the transfer conveyor 10 to a planer (not shown) where the pieces 12 will be further processed. Like the transfer conveyor 10, the unloading conveyor 11 may be formed of series of parallel endless chains 19 that may be provided without lugs.

An electronic reading unit 15 extends over the transfer conveyor 10 upstream of the piece turning apparatus 18. The electronic reading unit 15 reads a shape of the pieces 12 carried by the transfer conveyor 10. The endless chains 13 drive the pieces 12 within a reading range of the electronic reading unit 15, where the pieces 12 are read sequentially. The electronic reading unit 15 may comprise reading heads and/or electronic cameras (not shown), but any other suitable reading unit may be used to read the shape of the pieces 12. The electronic reading unit 15 may be linked to a computer unit (not shown) analysing the data gathered by the electronic reading unit 15. The computer unit then determines if a particular piece 12 has to be turned, for example to set its wany face up to maximize the planer mill recovery by minimizing waste. The reading unit 15 may also be used to keep track of each of the pieces 12 being carried by the transfer conveyor 10. Alternatively, an independent tracking unit may be used for that purpose. Of course, instead of being linked to the computer unit, the electronic reading unit 15 may instead directly analyze the data gathered and may determine if the piece 12 has to be turned.

A positioning unit is mounted along the transfer conveyor 10 upstream of the piece turning apparatus 18, for alignment of ends of the pieces along an alignment line when the pieces 12 are moving over a downstream portion of the transfer conveyor 10. Driving rollers 17 are projecting across the transfer conveyor 10 in front of a guiding member 16, for pushing the elongated pieces 12 against the guiding member 16. The guiding member 16 extends along the alignment line and the ends of the pieces 12 are pushed against. Each driving roller 17 is mounted between two adjacent endless chains 13 and at a level of the guiding member 16 along the transfer course 68.

The piece turning apparatus 18, positioned on a side of the downstream portion of the transfer conveyor 10 and synchronized therewith, selectively turns the pieces 12 in response to a piece turning control signal provided by the electronic reading unit 15 or by the computer unit. After the pieces 12 have been turned or not by the piece turning apparatus 18, they are carried toward the unloading conveyor 11 from where they will be carried to the planer (not shown).

The piece turning apparatus 18 shown in FIG. 1 is mounted next to the transfer conveyor 10. In the illustrated case, there are seven (7) turning hands 27 rotatably mounted onto the same number of carriages 28. Of course, a different number of turning hands 27 may also be used instead. The carriages 28 are distributively mounted onto an endless driving body 70 driving the turning hands 27 in displacement along running courses 72, 74 between opposite turning end courses 76,78 (shown in FIG. 2). One of the running courses, the running course 74 is parallel with the transfer conveyor 10 when the endless driving body 70 is mounted next to the conveyor 10. The carriages 28 support the turning hands 27 so that each one of the turning hands 27 successively moves into an engaging position 80 with an end of one of the pieces 12 as that piece 12 is carried by the transfer conveyor 10.

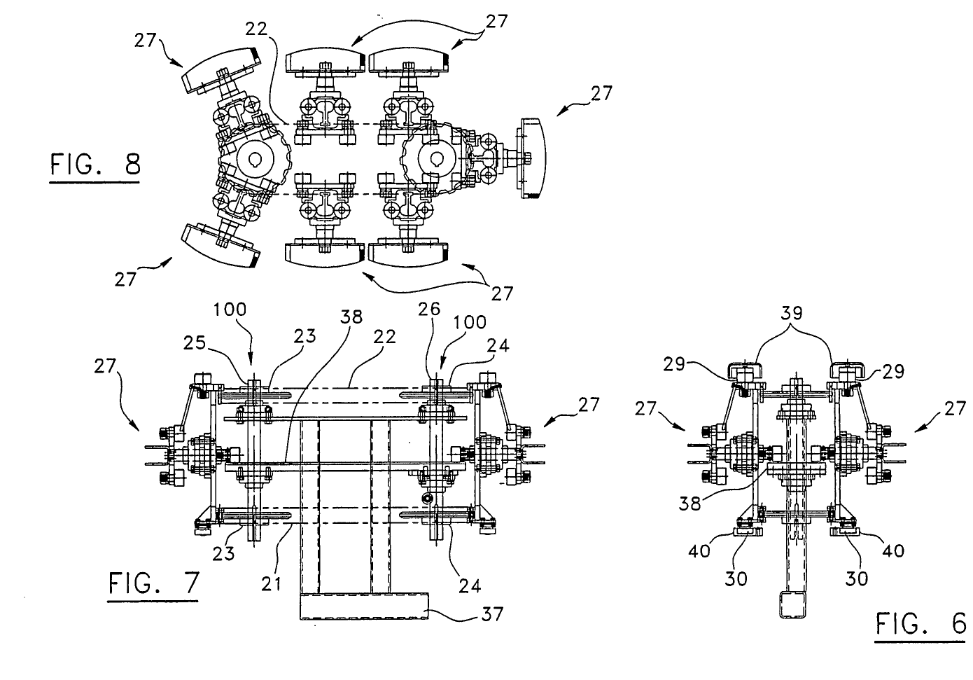

Better shown in FIGS. 6 to 8, a motor unit is operatively coupled to the endless driving body 70 in a driving engagement therewith. The motor unit comprises cogwheels assemblies 100 spaced from each other and respectively having rotation axes coinciding with centers of the turning end courses 76,78. The endless driving body 70 has upper and lower endless chains 21,22 guided by the cogwheel assemblies 100 along the turning end courses 76,78 and the running courses 72,74. Although both cogwheel assemblies 100 may be independent from each other, only one has to be a driving assembly. The carriages 28 are attached to the upper and lower endless chains 21,22.

As illustrated in the Figures, the cogwheel assemblies 100 may be formed by rotating shafts 25,26 mounted on a supporting frame 37, and cogwheels 23,24 axially mounted onto the rotating shafts 25,26. The rotating shafts 25,26 drive in rotation the driving wheels 23,24, thereby causing a displacement of the turning hands 27 along the running courses 72,74 and turning end courses 76,78.

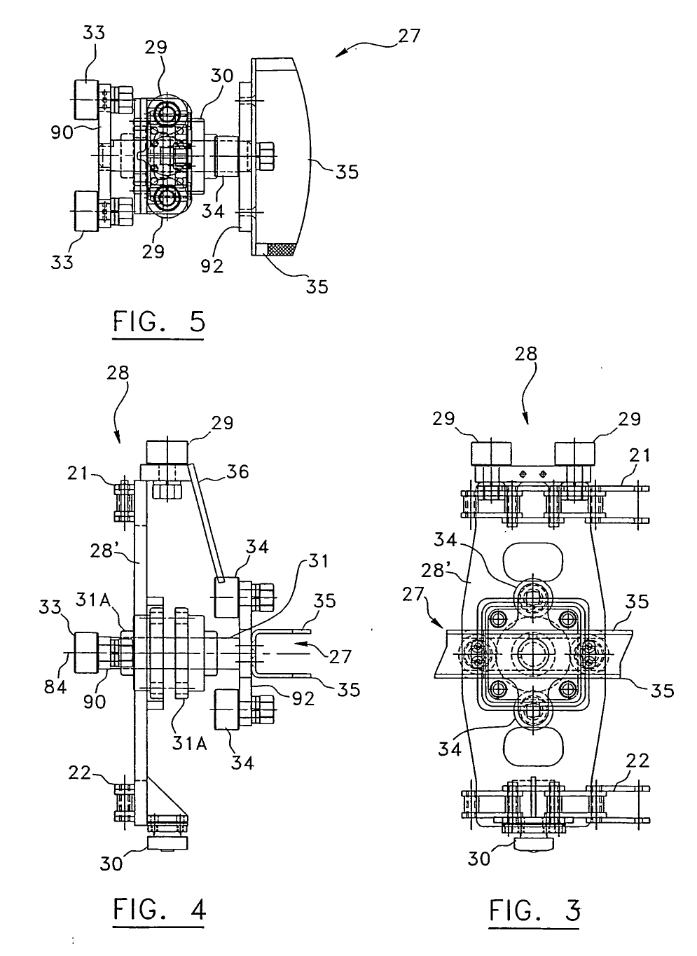

Referring to FIGS. 3 to 5, each turning hand 27 has upper and lower facing jaws 35 behind which an elongated shaft 31 is projecting. The elongated shaft 31 is rotatably supported by a bearing assembly 31A mounted onto a support plate 28′ of a corresponding one of the carriages 28. An end of one of the pieces 12 is engageable between the facing jaws 35 so that rotation of the turning hand 27 effects a turning of the piece 12 about a longitudinal axis 82 thereof when the end of the piece 12 is engaged in the turning hand 27.

The support plate 28′ is attached to the endless chains 21,22 on outer sides of the endless chains 21,22 opposite to sides engageable with the cogwheel assemblies 100.

Each turning hand 27 may have rotation fingers radially projecting in a cross configuration around a rotation axis 84 of the turning hand 27 (better shown in FIGS. 3 to 5). Opposite one of the fingers of each turning hand 27 form a first finger set 92 extending in front of the carriage 28, a second finger set 90 extending behind the carriage 28.

As shown in FIG. 6, a carriage guiding arrangement maintains the carriages 28 in operative position along the running courses 72,74. The carriage guiding arrangement comprises upper and lower guide tracks 39,40 facing each other and between which the carriages 28 engage when moving along the running courses 72,74. In the illustrated case, the guide tracks 39,40 are positioned along both running courses 72,74. However, the guide tracks 39,40 may be positioned instead for maintaining the carriages 28 in operative position only along a portion of the running course 74 where rotation of the turning hands 27 occurs. Upper and lower ends of the carriages 28 are provided with rollers 29,30 engageable in the guide tracks 39,40 and positioned for steadiness of the carriages 28 when the carriages 28 move between the guide tracks 39,40. The rollers 30 also contribute to axially support the carriages' weights.

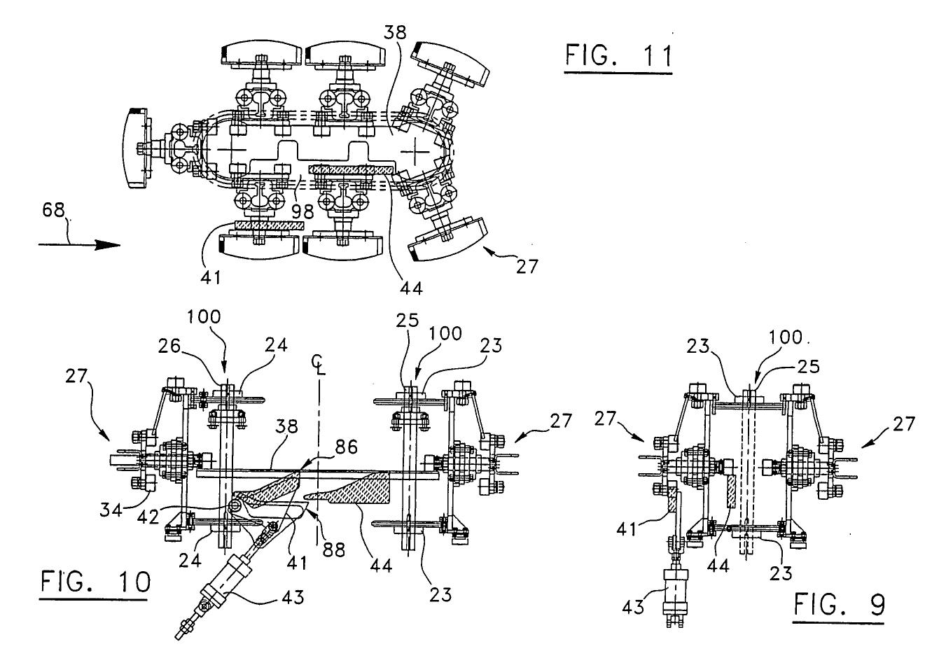

Referring now to FIGS. 9 to 11, the piece turning apparatus 18 also comprises a cam body 41 movable between an active position 86 in which the cam body drives one of the turning hands 27 in rotation using motion of the turning hand 27 while the turning hand 27 is in the engaging position 80, and an inactive position 88 in which the cam body 41 stands away from the turning hand 27. An actuator 43 controllably moves the cam body 41 about a pivoting point 42 between the active position 86 and the inactive position 88 in response to the piece turning control signal send by the computer unit or the electronic reading unit 15.

The cam body 41 extends in front of the carriage 28 and has a caming surface which, when the cam body 41 is moved into the active position 86, deflects a course of the first finger set 92 of one of the turning hands 27 moving in front of the caming surface of the cam body 41. The deflection of the first finger set 92 initiates a 180° rotation of the turning hand 27.

In the illustrated case, a stationary cam 44 is positioned after the cam body 41 and extends behind the carriage 28. The stationary cam 44 also has a caming surface which, once rotation of the turning hand 27 is initiated, deflects a course of the second finger set 90 of the turning hand 27 moving in front of the caming surface of the stationary cam 44. The deflection of the second finger set 90 completes the 180° rotation of the turning hand 27. The rotation fingers have ends provided with rollers 33,34 for rolling contact with the caming surfaces of the cam body 41 and the stationary cam 44.

Referring to FIGS. 6 to 8, a support member 38 bears the rollers 33 of the second finger set 90 from an end of the stationary cam 44 to a beginning of the cam body 41. The support member 38 has a hollow section 98 at a level of the cam body 41 and the stationary cam 44, thereby enabling rotation of the turning hands 27 at the level of the cam body 41 and the stationary cam 44.

Each carriage 28 has a flexible tab 36 releasably holding the first finger set 92 of the turning hand 27 in operative position wherein the turning hand 27 is ready to receive the end of one piece 12.

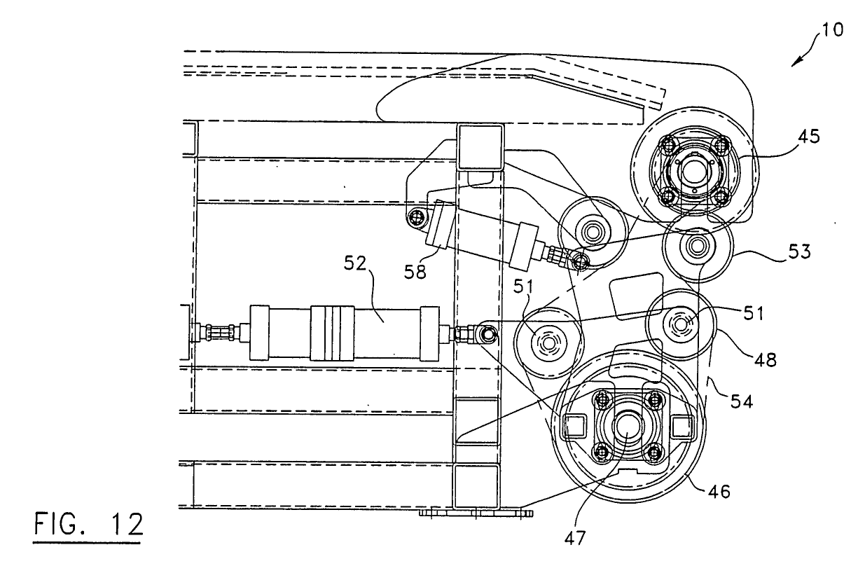

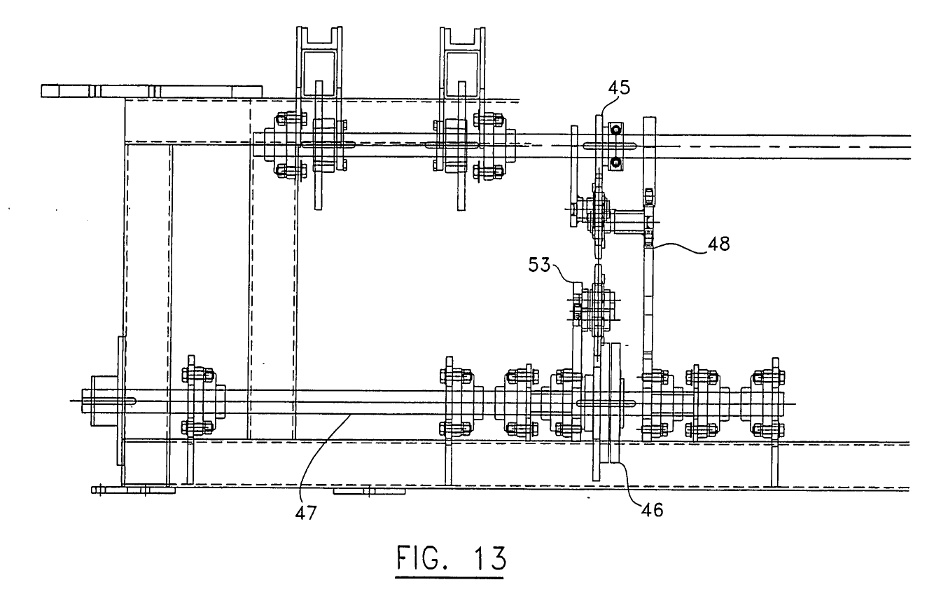

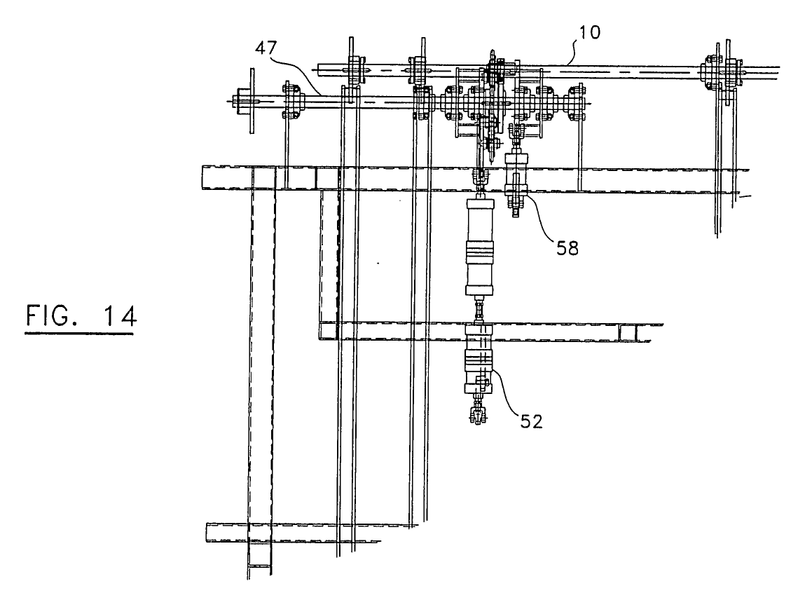

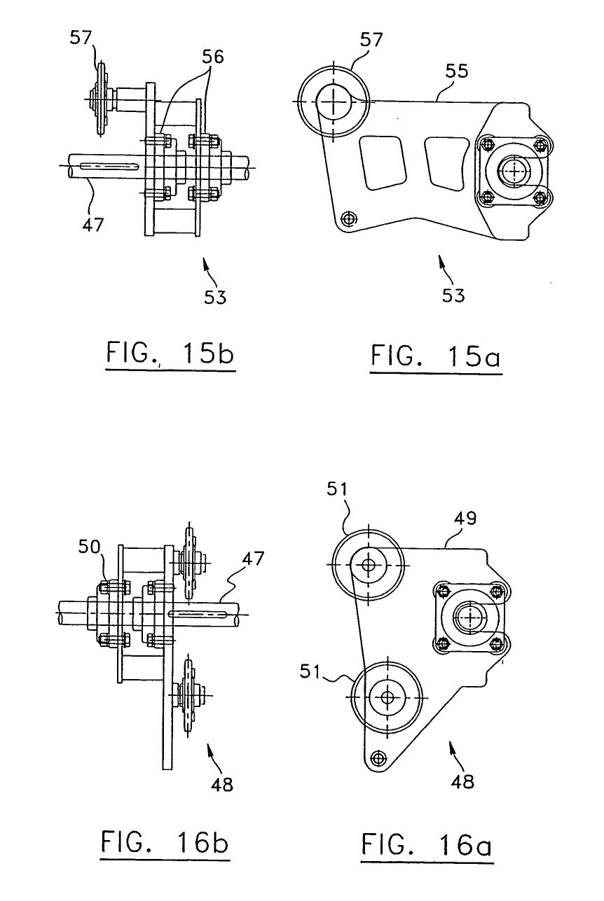

Referring to FIGS. 12, 13, 14, 15a, 15b, 16a and 16b, there is shown a first synchronizing unit mounted on the transfer conveyor 10 for synchronizing the same with the piece turning apparatus 18. A first cogwheel 45 mounted on a head shaft of the transfer conveyor 10 drives a second cogwheel 46 mounted on an intermediate shaft 47. Between these two cogwheels 45,46, a positioning device 48 (better shown in FIGS. 16a and 16b) rotates on the intermediate shaft 47. This positioning device 48 comprises a support 49, two flanking bearings 50 mounted at a bottom portion of the support 49 and allowing rotation of the intermediate shaft 47, and two free rolling cogwheels 51 fixed to an upper portion of the support 49. An actuator 52 (shown in FIG. 14) controls the positioning device 48. The movement of the positioning device 48 provides the synchronization and the correct positioning of the turning hand 27 according to the width of the pieces 12 used. An automatic tensioning device 53 (shown in FIGS. 13, 15a and 15b) maintains a constant tension in the driving chains 54 (shown in FIG. 12) between the two cogwheels 45,46. The tensioning device 53 may comprise a support 55, two main flanking bearings 56 mounted at the base of the support 55 for rotation of the intermediate shaft 47, a free rolling cogwheel 57 fixed to the superior portion of the support 55. Another actuator 58 maintains a constant tension in the chain 54.

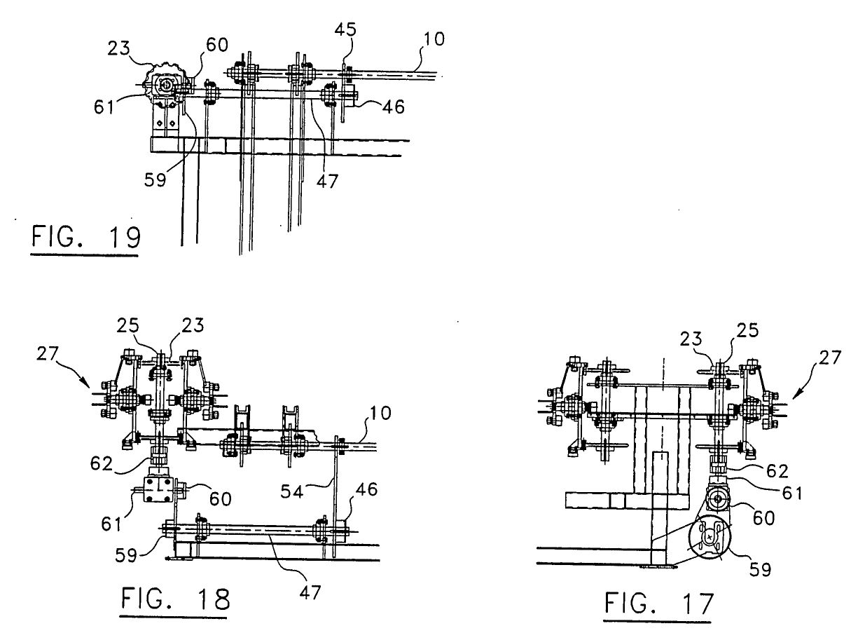

Referring now to FIGS. 17 to 19, there is shown a second synchronizing unit mounted on the piece turning apparatus 18 and operatively connected to the first synchronizing unit of the transfer conveyor 10. A cogwheel 59 is mounted at the other end of the intermediate shaft 47. The cogwheel 59 drives another cogwheel 60 mounted on a horizontal entry line of a bevel gearbox 61. On a vertical exit line of the bevel gearbox 61, a flexible coupling 62 drives the shaft 25 of the piece turning apparatus 18.

As previously described, the pieces 12 are laid down on the transfer conveyor 10, between the lugs 14, by a mechanical loading device (not shown). Each of the pieces 12 is then read by the electronic reading unit 15, for detecting the presence of a wany face. In the case where the piece 12 has a wany face, the volume of the wane and its position on the piece 12 may also be determined. Then, the information is transmitted to the computer unit (not shown), or directly analyzed by the reading unit 15, for determining if the piece 12 has to be turned or not. The decision to turn the piece 12 is linked to the piece 12 and will be used thereafter.

The piece turning apparatus 18, the transfer conveyor 10 and the driving rollers 17 illustrated in the Figures may be driven by a same motor unit, and may be synchronized with one another.

An electronic encoding device (not shown) may track the position of each of the pieces 12 in the system. After having been read by the electronic reading unit 15, the pieces 12 are pushed against the guiding member 16 by the driving rollers 17 for correctly aligning the ends of the pieces 12 with the turning hands 27 while the turning hands 27 are in the running course 74 parallel to the transfer conveyor 10 for engagement between the facing jaws 35. Other guides and funnels (not shown) may be used to insure correct engagement of the pieces 12 within the turning hands 27 on other axes.

Center to center distance of the lugs 14 of the endless chains 13 of the transfer conveyor 10 is greater than a center to center distance of the turning hands 27. The turning hands are thus driven along the running courses 72,74 at a slower speed than the conveying speed of the transfer conveyor 10. The turning hands 27, driven by the endless chains 21,22, are pivoting around the cogwheels 24 so that the turning hands 27 extends in front of the piece 12. The carrying speed of the transfer conveyor 10 is greater than the speed of the turning hands 27 along the running courses 72,74. Therefore, the ends of the pieces 12 progressively engage with the turning hands 27.

The position of a first face (called the edge) of the piece 12 is approximately ¾ inch upstream from the center of the jaws 35, that is to say the center of rotation of the support shaft 31. This position may be constant for all widths of pieces and is referred to as the turning position 63 (see FIG. 1). The position of the edge of the piece 12 with the jaws 35 is given herewith as an example and may differ depending of the configuration of the system.

Before the piece 12 reaches the turning position 63, the electronic reading unit 15 or the computer unit sends the piece turning control signal linked to this specific piece 12. If the decision is to turn the piece, the piece turning control signal is sent to the actuator 43 for moving the cam body 41 in the active position 86. The displacement of the turning hand 27 brings the first finger set 92 in contact with the caming surface of the cam body 41, thereby initiating the 180° rotation of the jaws 35. Due to the present configuration, the caming surface of the cam body 41 guides a 90° rotation of the facing jaws 35. The hollow section 98 within the support member 38 enables the rotation of the second finger set 90.

The first finger set 92 is easily disengaged from the flexible tab 36 upon initiation of the rotation of the first finger set 92. The stationary cam 44, positioned after the cam body 41, then deflects the course of the second finger set 90 to complete the 180° rotation of the facing jaws 35. Again, the caming surface of the stationary cam 44 guides a 90° rotation of the facing jaws 35, thereby returning the first finger set 92 under the flexible tab 36. Once the rotation is completed, the second finger set 90 engages the support member 38 so that the facing jaws 35 extends horizontally. The turning hands 27, driven by the endless chains 21,22, are pivoting around the cogwheels 23 and are progressively disengaged from the pieces 12. The piece 12 may thus continue its path towards the unloading conveyor 11.

If the decision is to not turn the piece 12, the cam body 41 is maintained in its inactive position 88. The course of the first finger set 92 will not be deflected by the cam body 41 and will still be held in position by the flexible tab 36. Therefore, the turning hand 27 will not rotate and the turning hand 27 will disengage from the end of the piece 12 without having turning it.

Although preferred embodiments of the present invention have been described in detail hereinabove and illustrated in the accompanying drawings, it is to be understood that the invention is not limited to these precise embodiments and that various changes and modifications may be effected therein without departing from the scope or spirit of the present invention.

Furthermore, the piece turning apparatus 18 may be used for turning pieces 12 having various widths. However, variations of the pieces' width may require different synchronization positions between the position of the lugs 14 of the transfer conveyor 10 and the turning position 63. These different synchronization positions may be obtained with the positioning device 48. The positioning device 48 changes the position of a main command chain linking the cogwheels 45,46. This change of position of the main command chain brings a variation of the distance between the turning position 63 and the center of the lugs 14. The actuator 52 is used for that purpose. The actuator 52 may be provided with a plurality of actuators assembled end to end and having different courses. The combination of these courses provides a multitude position set of the main command chain. To ensure a constant and adequate tension in the command chain linking the cogwheels 45,46, an actuator 58 maintains a constant pressure on the tensioning device 53.

The multitude position set of the main command chain may be predetermined according to specific pieces' widths. An operator may enter the pieces' widths in a computer and the positioning device 48 may automatically position the main command chain accordingly.

1. A piece turning apparatus for selectively turning elongated pieces carried in a sequence by a conveyor, comprising:
a number of turning hands, each turning hand having upper and lower facing jaws between which an end of one of the elongated pieces is engageable so that rotation of the turning hand effects a turning of the one of the elongated pieces about a longitudinal axis thereof when the end of the one of the elongated pieces is engaged in the turning hand;
a number of carriages to which the turning hands are respectively rotatably mounted;
an endless driving body mountable next to the conveyor and defining running courses between opposite turning end courses, one of the running courses being parallel with the conveyor when the endless driving body is mounted next to the conveyor, the carriages being distributively mounted onto the endless driving body and supporting respectively the turning hands so that each one of the turning hands successively moves into an engaging position with an end of one of the elongated pieces as the one of the elongated pieces is carried by the conveyor;
a motor unit operatively coupled to the endless driving body in a driving engagement therewith;
a cam body movable between an active position in which the cam body drives one of the turning hands in rotation using motion of the one of the turning hands while the one of the turning hands is in said engaging position, and an inactive position in which the cam body stands away from the one of the turning hands; and
an actuator controllably moving the cam body between the active and inactive positions in response to a piece turning control signal.

2. The piece turning apparatus according to claim 1, wherein
the motor unit comprises cogwheel assemblies spaced from each other and respectively having rotation axes coinciding with centers of the turning end courses, at least one of the cogwheel assemblies being a driving assembly; and
the endless driving body comprises upper and lower endless chains guided by the cogwheel assemblies along the turning end courses and the running courses, the carriages being attached to the upper and lower endless chains.

3. The piece turning apparatus according to claim 1, comprising a carriage guiding arrangement maintaining the carriages in operative position at least along a portion of the running course where rotation of the turning hands occurs.

4. The piece turning apparatus according to claim 3, wherein the carriage guiding arrangement comprises upper and lower guide tracks facing each other and between which this carriages engage when moving along the running courses.

5. The piece turning apparatus according to claim 4, wherein the carriages have upper and lower ends provided with rollers engageable in the guide tracks and positioned for steadiness of the carriages when the carriage move between the tracks.

6. The piece turning apparatus according to claim 2, wherein each carriage comprises:
a support plate attached to the endless chains on outer sides thereof opposite to sides engageable with the cogwheel assemblies; and
a bearing mounted onto the support plate and rotatably supporting a corresponding one of the turning hands.

7. The piece turning apparatus according to claim 6, wherein each turning hand comprises shaft projecting behind the jaws and rotatably supported by the bearing of a corresponding one of the carriages.

8. The piece turning apparatus according to claim 1, wherein
each turning hand comprises rotation fingers radially projecting in a cross configuration around a rotation axis of the turning hand;
the cam body has a caming surface which, when the cam body is moved into said active position, deflects a course of one of the fingers of one of the turning hands moving in front of the caming surface of the cam body, thereby in initiating a 180° rotation of said one of the turning hands; and
the piece turning apparatus further comprises a stationary cam positioned after the cam body, the stationary cam having a caming surface which, once rotation of said one of the turning hands is initiated, deflects a course of a next one of the fingers of said one of the turning hands moving in front of the caming surface of the stationary cam, thereby completing the 180° rotation of said one of the turning hands.

9. The piece turning apparatus according to claim 8, wherein the rotation fingers have ends provided with rollers for rolling contact with the caming surfaces of the cam body and the stationary cam.

10. The piece turning apparatus according to claim 8, wherein
opposite ones of the fingers of each turning hand form respective finger sets, a first one of which extending in front of a corresponding one of the carriages, a second one of which extending behind said corresponding one of the carriages; and
one of the cam body and the stationary cam extends in front of said corresponding one of the carriages, the other one of the cam body and the stationary cam extending behind said corresponding one of the carriages.

11. The piece turning apparatus according to claim 10, comprising a support member bearing the rollers of the second finger set from an end of the stationary cam to a beginning of the cam body, the support member having a hollow section at a level of the cam body and the stationary cam, thereby enabling rotation of the turning hands at said level.

12. The piece turning apparatus according to claim 10, wherein each carriage has a flexible tab releasably holding one of fingers of a corresponding one of the turning hands in operative position wherein the corresponding one of turning hands is ready to receive the end of one of the elongated pieces.

13. A system for selectively turning elongated pieces, comprising:
a conveyor for receiving and carrying the elongated pieces in a sequence along a transfer course, the elongated pieces having one end extending along an alignment line when moving over a downstream portion of the conveyor; and
a piece turning apparatus as defined in claim 1, positioned on a side of the downstream portion of the conveyor and synchronized therewith, for engagement of the ends of the elongated pieces between the jaws of the turning hands respectively.

14. The system according to claim 13, further comprising a piece positioning unit mounted along the conveyor upstream of the piece turning apparatus, for alignment of the elongated pieces along the alignment line.

15. The system according to claim 14, wherein the piece positioning unit comprises a guiding member extending along the alignment line, against which the ends of the elongated pieces are pushable.

16. The system according to claim 15, wherein the piece positioning unit comprises driving rollers projecting across the conveyor in front of the guiding member, for pushing the elongated pieces against the guiding member.

17. The system according to claim 13, comprising a reading unit extending over the conveyor upstream of the piece turning apparatus, for reading a shape of the pieces carried by the conveyor and providing the piece turning control signal to the actuator.

18. The system according to claim 13, wherein the conveyor comprises of endless chains in parallel with and spaced from one another.

19. The system according to claim 18, wherein the endless chains have lugs projecting at regular intervals.
